(19) United States
(12) Patent Application Publication
(10) Pub. No.: US 2007/0117599 A1
(43) Pub. Date: May 24, 2007

(54) Handheld computing and communication device with a multi-position keyboard-lid

(76) Inventor: Rajendra Kumar, Akron, OH (US)

Correspondence Address: HAHN LOESER & PARKS, LLP, One GOJO Plaza, Suite 300, AKRON, OH, 44311-1076, US

(21) Appl. No.: 10/566,530

(22) PCT Filed: Jul. 30, 2004
(86) PCT No.: PCT/IB04/51349

§ 371 Date: Jan. 5, 2007

Related U.S. Application Data
(60) Provisional application No. 60/491,049, filed on Jul. 30, 2003.

(51) Int. Cl. H04M 1/00

(52) U.S. Cl. 455/575.3

(57) ABSTRACT

A portable, digital electronic device (10) is disclosed which comprises a host unit (20), including a display (21), and a keyboard module (40) connected to the host unit (20) and including at least one group of keys (41, 42, 43). The keyboard module (40) is moveable between at least two allowable positions with respect to the host unit (20), wherein a first allowable position of the at least two allowable positions results in the keyboard module (40) substantially covering the display (21), and wherein a second allowable position of the at least two allowable positions results in the display (21) being at least partially exposed.

### CROSS-REFERENCE TO RELATED APPLICATIONS/INCORPORATION BY REFERENCE

U.S. Pat. No. 5,548,477 issued on Aug. 20, 1996 is incorporated by reference herein in its entirety.

This application claims priority to U.S. provisional patent application Ser. No. 60/491,049 filed on Jul. 30, 2003, which is incorporated herein by reference in its entirety.

### TECHNICAL FIELD

Certain embodiments of the present invention relate to the field of handheld computers or devices such as, for example, portable digital assistants or PDA for short, smart phones, e-mail devices, and cell phones. More particularly, certain embodiments of the present invention relate to portable handheld devices which enable a user to enter data through an attachable keyboard.

### BACKGROUND OF THE INVENTION

The handheld computer industry has created PDA devices for data entry via a touch-sensitive on-screen panel. PDA devices are handheld devices with information input means and personal information management (PIM) software such as to-do lists, contact lists, and appointments. PDA devices have significant processing capabilities related to performing the desired functions.

One example of such a device is the PocketPC model Axim from Dell Computer Corporation of Austin, Tex. PDA devices accept data through a stylus in the form of written input as well as through on-screen keyboards. However, many users prefer the conventional keys with tactile feedback for data input. For that reason, some manufactures provide such keys in addition to the pen-input capability described above. An example of such a device is PDT-8100 from Symbol Technologies Inc. of Holtsville, N.Y. However, the addition of the keyboard, along with the display, adds significant length to the device, thereby making the device too large for many applications. U.S. Pat. No. 5,548,477 teaches a special keyboard lid that adds key-entry capability without increasing the length of the device. However, such an accessory is prone to damage in case of accidental drops or impact against another object.

Yet another drawback of the prior art, especially when applied to harsh environments of vertical applications of barcodes, is that the display screen is exposed to the elements when the unit is not in use.

Accordingly, there is a need for a PDA device that provides additional means of user input, in particular a tactile keyboard. The PDA device, described above, needs to be durable like an average cell phone. Also, it must have an increased protection against accidental impacts on the display. Lastly, it is desirable that the new PDA device can be implemented by employing readily available off-the-shelfPDA devices without requiring complex development of customized products.

Portable data entry devices are known for use in automatic identification systems, such as the bar code industry as an example. Portable data entry devices such as bar code scanners, radio frequency identification devices, and key-entry based hand held computers are used for applications such as inventory tracking, in store order entry, package delivery, route sales, or the like. Various dedicated products have been developed for this purpose, such products including a bar code scanning system, a radio frequency identification system, a data processing system, and communications features. Although such devices provide desired attributes of portability along with data capture and communication capabilities, the devices are expensive and relatively inflexible in their operation.

Compared with portable data entry devices, PDA devices have the benefit of the economies of scale. Therefore PDA devices are less expensive, more compact, and offer higher performance in several areas by employing new technologies at a faster pace. Consequently, it would be advantageous to employ PDA devices for portable data entry applications. However, PDA devices lack several key features essential to many of the portable data entry applications, such as barcode scanners, keyboards with numeric and/or alphabetic characters, wireless communication systems, and radio frequency identification readers.

Another key feature missing in the PDA devices is ruggedness, which is essential when the user is mobile during the use of the device. (In contrast, the users of PDA devices are generally stationary during the actual use of the device). Additionally, PDA devices are not configured with a form factor to allow simple portable data entry in the variety of different environments in which portable data entry devices are used.

Some manufacturers of the barcode industry have attempted to solve these problems by licensing the internal electronic assemblies of the PDA devices from their suppliers and packaging them with portable data entry features in custom designed cases. Examples of such products are models SPT-1500 and SPT-1700 from Symbol Technologies of Holtsville, N.Y. However, this process is time consuming and requires expensive re-engineering, which has to be repeated with the introduction of each new PDA. Also, since the resulting devices are produced in smaller volumes, significant benefits of using the PDA technology are lost.

Further limitations and disadvantages of conventional, traditional, and proposed approaches will become apparent to one of skill in the art, through comparison of such systems with the present invention as set forth in the remainder of the present application with reference to the drawings.

### BRIEF SUMMARY OF THE INVENTION

An embodiment of the present invention provides a portable, digital electronic device comprising a host unit having a display and a keyboard module connected to the host unit and having at least one grouping of keys. The keyboard module is moveable between at least two allowable positions with respect to the host unit, wherein a first allowable position of the at least two allowable positions results in the keyboard module substantially covering the display, and wherein a second allowable position of the at least two allowable positions results in the display being at least partially exposed.

An embodiment of the present invention provides a method for using a portable, digital electronic device. The method comprises attaching a keyboard module of the device to a host unit of the device. The keyboard module includes at least one group of keys and the host unit includes a display. The method further comprises moving the keyboard module between at least two allowable positions with respect to the host unit, wherein a first allowable position of the at least two allowable positions results in the keyboard module substantially covering the display, and wherein a second allowable position of the at least two allowable positions results in the display being at least partially exposed.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates a top perspective view of a first exemplary embodiment of a portable, digital electronic device, in accordance with various aspects of the present invention.

FIGS. 2A-2C illustrate cross-sectional views, taken along the line 2-2 in FIG. 1, showing several exemplary positions of a keyboard module of the portable device of FIG. 1 with respect to a host unit of the portable device of FIG. 1, in accordance with various aspects of the present invention.

FIG. 3 illustrates an end view of the exemplary embodiment of the portable, digital electronic device of FIG. 1, in accordance with various aspects of the present invention.

FIG. 4 illustrates a cross-sectional view of an exemplary end module of the portable device of FIG. 1 along the line 4-4 of FIG. 1, in accordance with various aspects of the present invention.

FIG. 5 illustrates a top perspective view of a second exemplary embodiment of a portable, digital electronic device, in accordance with various aspects of the present invention.

FIGS. 6-7 illustrate an exemplary embodiment of a nub and rail mechanism of the device of FIG. 5, in accordance with various aspects of the present invention.

### DETAILED DESCRIPTION OF THE INVENTION

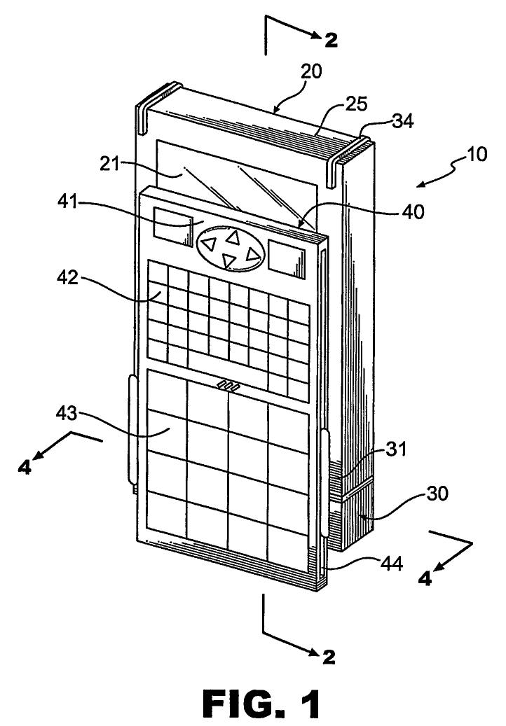

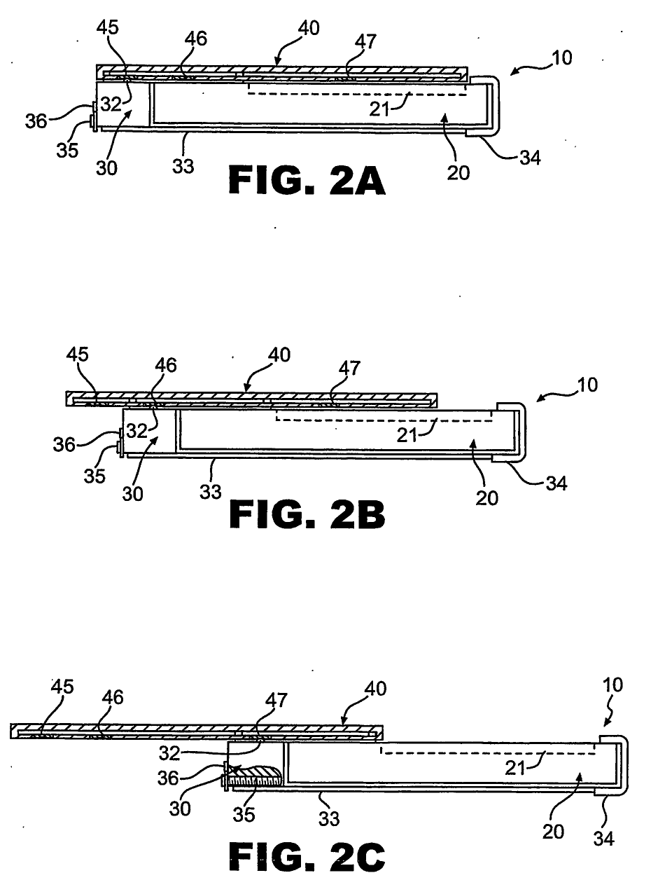

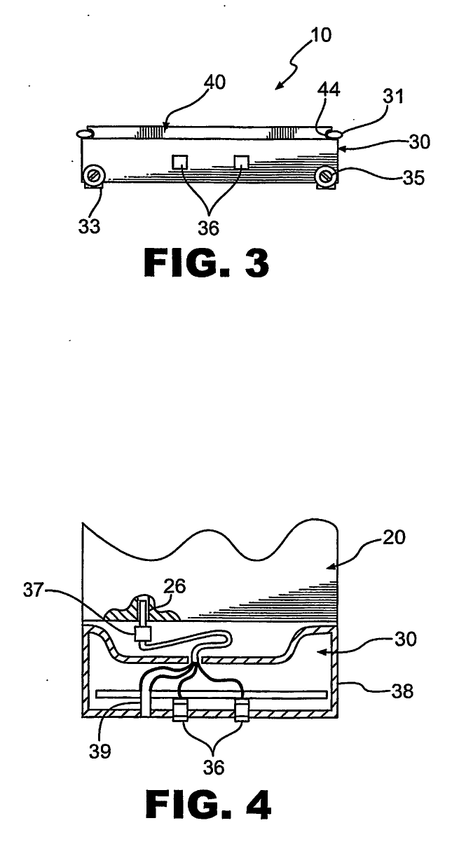

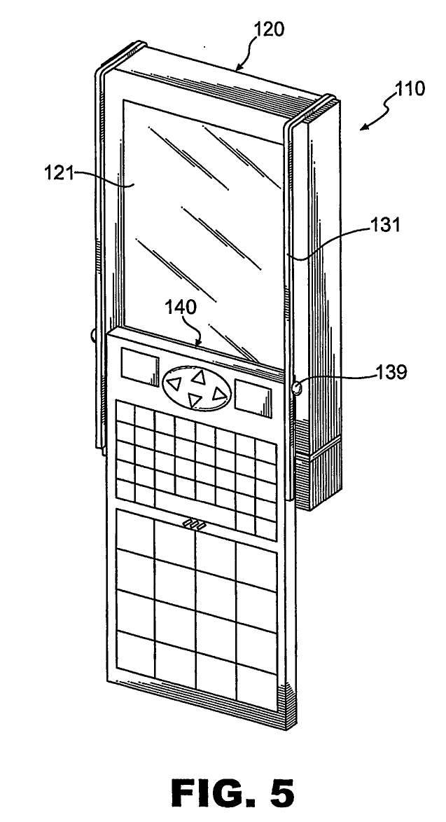

FIG. 1 illustrates a top perspective view of an exemplary device in accordance with an embodiment of the present invention showing both a host unit and a keyboard module. FIGS. 2A, 2B, and 2C are cross-sectional views taken along the line 2-2 in FIG. 1, showing the keyboard module in a closed position in FIG. 2A, a partially open position in FIG. 2B, and a fully open position in FIG. 2C. FIG. 3 is an end view of the exemplary device. FIG. 4 is a cross sectional view of an end-module along the line 4-4 in FIG. 1. FIGS. 5-7 show an alternative embodiment of the current invention.

FIG. 1 illustrates a top perspective view of a first exemplary embodiment of a portable, digital electronic device 10, in accordance with various aspects of the present invention. The device 10 includes a host unit 20, a keyboard module 40, and an end module 30. For example, the host unit 20 may comprise a commercially available, off-the-shelf PDA having associated PDA functionality. On the front side, the host unit has a display 21. Two rails 31 are mounted on the end-module 30, oriented one on each side of the keyboard module 40.

FIGS. 2A-2C illustrate cross-sectional views, taken along the line 2-2 in FIG. 1, showing several exemplary positions of the keyboard module 40 of the portable device 10 of FIG. 1 with respect to the host unit 20 of the portable device 10 of FIG. 1, in accordance with various aspects of the present invention. FIG. 3 illustrates an end view of the exemplary embodiment of the portable, digital electronic device of FIG. 1, in accordance with various aspects of the present invention.

As best seen in FIGS. 2A-2C, the end module 30 also includes a flexible metal strip 33, which is connected to a retaining bracket 34 that fits around the top end of the host unit 20. An adjusting screw 35 helps tighten the strip 33 and the bracket 34 around the host unit 20 and hence securing the end module housing 38 (see FIG. 4) to the host unit housing 25 (see FIG. 1). The keyboard module 40 has a matching groove 44 mounted on each side, which mates with and slides along the rails 31 from a closed position shown in FIG. 2A, through a partially open position shown in FIG. 2B, to an open position shown in FIG. 2C. In accordance with an alternative embodiment of the present invention, the matching grooves 44 may be mounted on the end module 30 which is attached to the host unit 20, and the rails 31 may be mounted on the keyboard module 40.

In accordance with further alternative embodiments of the present invention, the matching grooves 44 may be an integral part of the keyboard module 40 (e.g., a molded part of the housing of the keyboard module 40), the host unit 20, or the end module 30. The rails 31 may be an integral part of the keyboard module 40, the host unit 20, or the end module 30. Other alternative combinations are possible as well.

The end module 30, rails 31, flexible metal strip 33, retaining bracket 34, adjusting screw 35, and matching grooves 44 constitute a holding mechanism, in accordance with various embodiments of the present invention.

The end module 30 includes an electrical connector 32 on the top side, which mates with mating connectors 45, 46 and 47 when the keyboard module 40 is in a closed position shown in FIG. 2A, a predetermined partially open position shown in FIG. 2B, and a completely closed position shown in FIG. 2C, respectively. This arrangement allows the host unit 20 to sense the position of the keyboard module 40 and thereby adapt the content of display 21 in accordance with the position of the keyboard module 40. The end module 30 is in electrical communication with the host unit 20 via an electrical interface (not shown), in accordance with an embodiment of the present invention. For example, the electrical interface may be a connector on the bottom of the host unit 20 mated with an electrical connector on the top of the end module 30, in accordance with an embodiment of the present invention. As an alternative, the end module 30 is in communication with the host unit 20 via a wireless interface (not shown). Alternatively, the electrical connector 32 may be mounted directly on or be an integral part of the front of the host unit 20.

As an example, when the keyboard module 40 is in the closed position, the host unit 20 may turn off or go into a standby mode. When the keyboard module 40 is in a partially open position, the host unit 20 may use only a predetermined top portion of the display 21 as an active user interface. This may be useful in a handset mode and in an e-mail mode requiring intensive thumb keying of e-mail messages.

The electrical connector 32 and the mating connectors 45, 46, and 47 constitute at least part of a position sensing mechanism. The host unit 20 knows which mating connector (45, 46, or 47) is active (i.e., which mating connector is engaged with the electrical connector 32). The position sensing mechanism outputs a position signal to the host unit 20. For example, in accordance with an embodiment of the present invention, the connected mating connector (45, 46, or 47) passes a position signal from the keyboard module 40 to the host unit 20 via the electrical connector 32. The position signal may be, for example, a simple digital logic level or a 2- bit binary code. Other position signals are possible as well.

In accordance with an embodiment of the present invention, the electrical connector 32 and the mating connectors 45, 46, and 47 also carry electrical power to operate the keyboard module 40 and carry input and output signals between the keyboard module 40 and the host unit 20. In accordance with an alternative embodiment of the present invention, the keyboard module 40 communicates with the host unit 20 via a wireless input/output link (not shown). Also, in accordance with an alternative embodiment of the present invention, the keyboard module 40 includes its own power source such as, for example, a battery.

The grooves 44 are designed to be flexible so that, when subjected to an otherwise damaging impact, the rails 31 come out of the grooves 44, thereby releasing the keyboard module 40 from the host unit 20 and preventing possible damage to the device 10. This situation will arise when the portable electronic device 10 is dropped or collides with another object when the keyboard module 40 is protruding outward as shown in FIGS. 2B and 2C.

FIG. 4 illustrates a cross-sectional view of an exemplary end module 30 of the portable device 10 of FIG. 1 along the line 4-4 of FIG. 1, in accordance with various aspects of the present invention. The end module 30 of the current invention also includes a charging adapter configuration, which can be best seen in FIG. 4. A charging jack 26 is found in a majority of host units in the market such as Axim model Pocket PC devices made by Dell Computer Corporation of Austin, Tex. The jack 26 of the host unit 20 is connected via a plug 37, which in turn is connected to another jack 39 included in the end module 30. Such a configuration allows for a charger (not shown) of the host unit 20 to be used to charge the batteries (not shown) of the portable digital electronic device 10. The charge jack 26 is also connected to charger contact-pair 36, which can be used in conjunction with a charging cradle (not shown).

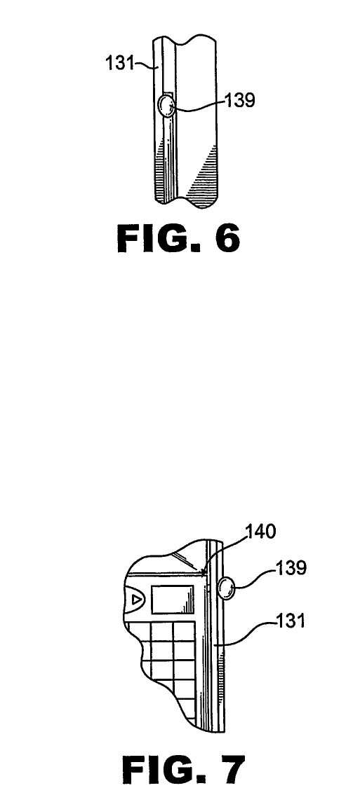

FIG. 5 illustrates a top perspective view of a second exemplary embodiment of a portable, digital electronic device 110, in accordance with various aspects of the present invention. FIGS. 6-7 illustrate an exemplary embodiment of a nub and rail mechanism of the device 110 of FIG. 5, in accordance with various aspects of the present invention.

In such an embodiment, instead of the groove and rail mechanism described above, a rail and an angled oval nub mechanism may be used such that, at a certain orientation of the keyboard module 140, the keyboard module 140 can be moved freely while the nub 139 travels along the associated rail 131. This mechanism is shown in FIGS. 5 through 7, where keyboard module 140 includes angled oval nubs 139, one on each side, which move along the rails 131. The nubs 139 prevent the keyboard module 140 from detaching from the host unit 120 as the keyboard module 140 is being moved with respect to the host unit 120. However, the keyboard module 140 releases from the host unit 120 when the device 110 is subjected to an impact that may otherwise damage the device 110.

When a desired position of the keyboard module 140 is reached, the keyboard module 140 is pressed down, thereby causing the tightening of the angled oval nubs 139 under the rails 131. With such a mechanism, the keyboard module 140 may also be flipped and closed as a lid with the keys facing inside toward the display 121.

Referring to FIG. 1, the keyboard module 40 includes a portion 41 having navigation keys such as a cursor control key and keys for starting a scanner. There is another portion 42 having an arrangement of keys in the popular typewriter arrangement, also referred to as the QWERTY arrangement. Yet another portion 43 has an arrangement of keys substantially like the arrangement found in cell phones.

In accordance with an alternative embodiment of the current invention, the keyboard module 40 may include an entirely different arrangement of keys, for example an arrangement substantially similar to those found in barcode-based portable data entry devices such as model PTC-960 (not shown) from Symbol Technologies of Holtsville, N.Y. Other key arrangements are possible as well, corresponding to various application of the portable device 10.

For example, the keyboard module 40 may be used for portable data entry into the host unit 20 for use as an automatic identification system such as a bar code scanner, a radio frequency identification device, and a key-entry device. Such applications may include, for example, inventory tracking, in store order entry, package delivery, route sales, or the like.

In accordance with various embodiment of the present invention, the portable digital electronic device 10 conforms to one of a hand-held form factor and a tablet form factor.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1-32. (canceled)

33. A portable electronic device comprising:
a host unit, including a display; and
a keyboard module selectively connected to said host unit and including at least one group of keys, and said keyboard module being moveable between at least two allowable positions with respect to said host unit, and a holding mechanism to detachably hold the keyboard module to the host unit.

34. The device of claim 33 further comprising a position sensing mechanism, said position sensing mechanism being mounted on at least one of said host unit, said keyboard module, and said holding mechanism and outputting a position signal to said host unit corresponding to one of said at least two allowable positions such that said host unit adapts a display content of said display in response to said position signal.

35. The device of claim 34 wherein said position sensing mechanism comprises an electrical connector and at least one mating connector provided between the host unit and keyboard module, which carry power to operate said keyboard module and carry input and output signals between said keyboard module and said host unit.

36. The device of claim 33 wherein said holding mechanism releases said keyboard module from said host unit when said keyboard module is attached thereto, and the device is subjected to an impact that may otherwise damage said device.

37. The device of claim 33 wherein said keyboard module includes a power source and a wireless input/output link to communicate with said host unit.

38. The device of claim 33 wherein said host unit conforms to one of a hand-held form factor and a tablet form factor.

39. A portable electronic device comprising:
a host unit, including a display; and
a keyboard module connected to said host unit and including at least one group of keys, and said keyboard module being moveable between at least two allowable positions with respect to said host unit, wherein a first allowable position of said at least two allowable positions results in said keyboard module substantially covering said display, and having a position sensing mechanism comprising an electrical connector mounted on said host unit or said holding mechanism and at least one mating connector mounted on said keyboard module, said electrical connector and said at least one mating connector engaging and disengaging with each other as said keyboard module moves between said at least two allowable positions.

40. A portable, digital electronic device, said device comprising:
a host unit, including a display; and
a keyboard module connected to said host unit and including at least one group of keys, and said keyboard module being moveable between at least two allowable positions with respect to said host unit, wherein a first allowable position of said at least two allowable positions results in said keyboard module substantially covering said display, and wherein a second allowable position of said at least two allowable positions results in said display being at least partially exposed, wherein the display content on the display is adapted to the exposed portion of the display, and having a holding mechanism to securely and detachably hold said keyboard module to said host unit in one of said at least two allowable positions.

41. The device of claim 40 further comprising a position sensing mechanism, said position sensing mechanism being mounted on at least one of said host unit, said keyboard module, and outputting a position signal to said host unit corresponding to one of said at least two allowable positions such that said host unit adapts a display content of said display in response to said position signal.

42. The device of claim 41 wherein said position sensing mechanism comprises an electrical connector mounted on a front side of said host unit and at least one mating connector mounted on a back side of said keyboard module and facing said front side of said host unit, said electrical connector and said at least one mating connector engaging and disengaging with each other as said keyboard module moves between said at least two allowable positions.

43. The device of claim 42 wherein a number of said at least one mating connector is three and wherein each of said three mating connectors are positioned on said keyboard module to engage with said electrical connector at said at least two allowable positions including a first allowable position wherein said keyboard module is positioned such that substantially all of said display is covered, a second allowable position wherein said keyboard module is positioned such that a predefined portion of said display is exposed, and a third allowable position wherein said keyboard module is positioned such that substantially all of said display is exposed.

44. The device of claim 42 wherein said electrical connector and said at least one mating connector carry power to operate said keyboard module and carry input and output signals between said keyboard module and said host unit.

45. The device of claim 40 wherein said holding mechanism releases said keyboard module from said host unit when said device is subjected to an impact that may otherwise damage said device.

46. The device of claim 40 wherein said keyboard module includes a power source and a wireless input/output link to communicate with said host unit.

47. The device of claim 40 wherein said host unit conforms to one of a hand-held form factor and a tablet form factor.
